(19) United States
(12) Patent Application Publication
(10) Pub. No.: US 2005/0086818 A1
(43) Pub. Date: Apr. 28, 2005

(54) Structure of a ruler

(76) Inventor: Fu-Chi Lin, Taipei Hsien (TW)

Correspondence Address: Lin, Fu-Chi, 7F., No. 213 Civic Boulevard. Sec. 4, Taipei, 105, TW

(21) Appl. No.: 10/697,818

(22) Filed: Oct. 28, 2003

(51) Int. Cl. B43L 7/10

(52) U.S. Cl. 33/465

(57) ABSTRACT

An improvement structure of a ruler, comprising: two rulers; an axis, composed of a hollow axis and a fixed axis, said hollow axis and said fixed axis being formed as one respectively to the ends of said rulers, said hollow axis being composed of an upper ring and an lower ring to combine said two rulers as one. Therefore, an improvement structure of the ruler of fewer elements, low cost and replacing rapidly can be obtained.

### FIELD OF THE INVENTION

The present invention is related to an improvement structure of a ruler, especially for an improvement structure of an open ruler.

### BACKGROUND OF THE INVENTION

A ruler is compatible and generally used to survey and draw lines, and its preferred length is 20 cm. If someone surveys a length above 50 cm, he/she should use a line tape ruler, but the line tape ruler is just used to measure length but lacking the function of drawing lines, and functions of a ruler are not totally developed. So someone developed a structure of an open ruler, referring to FIG. 1 illustrated the explosive view of a structure of a prior open ruler. Please referring to FIG. 2 and FIG. 3 illustrated respectively the assembly view and the cross-section view of a structure of a prior open ruler, which is provided two ruler 1′ and 1″, an opening 11 set at one end of the ruler l′, and two holes 12 set on the opening 11; another ruler 11 responded to ruler 1′, an opening 13 set below the opening 14, and two holes 14 set above the opening 13; an upper piece 21 set in the opening 11 of the ruler 1′, two holes 211 set on the upper piece 21, in which two holes 211 are responded to holes 12 of opening 11 to combine the ruler 1′ and the upper piece 21 by two fixed elements 4, and a fixed holes 212 set on the upper piece; a lower piece 22 set in the opening 13 of the ruler 1″, two holes 221 of the lower piece, in which two holes are responded to holes 14 of the opening 13 to combine the ruler 1″ and the lower piece 22 by two fixed element 4, and a fixed hole 222 set on the below piece 22; a fastener 3 fixed between the fixed holes 212 of the upper piece 21 and the fixed holes 222 of the lower piece 22 by a gasket 31 to be an axis 2; by means of the axis 2, a structure of the open ruler 1 can be obtained to draw lines and measure length. But, the structure has disadvantages listed below:

1. Too many elements to make non-convenience of productivity and high cost:
Due to the axis is composed of the upper piece and the lower piece each coordinated with a fixed element and a gasket, and it is needed to fix the axis to the ruler by several fixed elements, and too many elements make non-convenience of assembly and high cost.

2. Cannot replace new ruler:
After used for a long time, the scale division of a ruler is going to fuzzy, or due to the miss-usage of a person, the combination structure cannot be replaced, and this induces resource wastage.

Due to the disadvantages of the structure of prior ruler, the inventor felt that is not very perfect and thought for years to improve it to an improvement structure of the ruler to reach the benefits of replacing rapidly and reducing cost.

### SUMMARY OF THE INVENTION

The primary of the present invention is to design an improvement ruler structure of replacing rapidly and reducing material cost.

To achieve above object, the improvement structure of a ruler of the present invention, at least comprising, two ruler; an axis composed of a hollow axis and a fixed axis, and the hollow axis and the fixed axis are formed as one respectively to the end of the ruler. Therefore, an improvement ruler structure of replacing rapidly and reducing material cost can be reached.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an explosive view of a structure of a open ruler of a prior art.

FIG. 2 is an assembly view of a structure of a open ruler of a prior art.

FIG. 3 is a cross-section view of A-A′ of FIG. 2.

FIG. 4 is an explosive view of the present invention.

FIG. 5 is an assembly view of the present invention.

FIG. 6 is an cross-section view of B-B′ of the present invention.

FIG. 7 is an embodiment of the present invention.

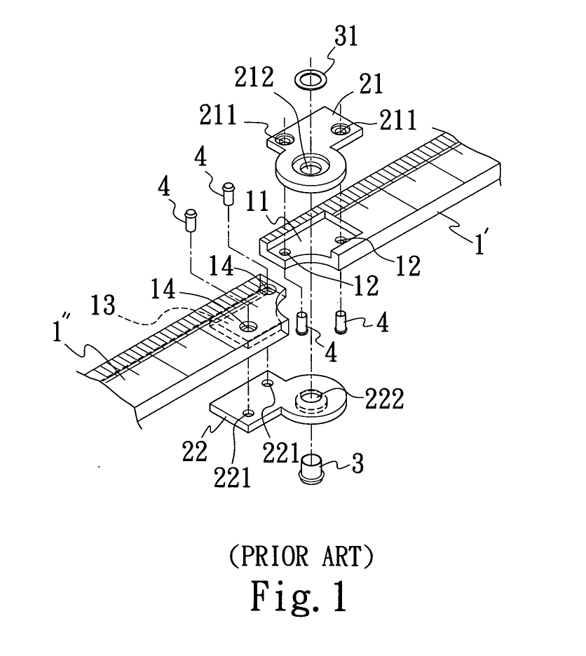

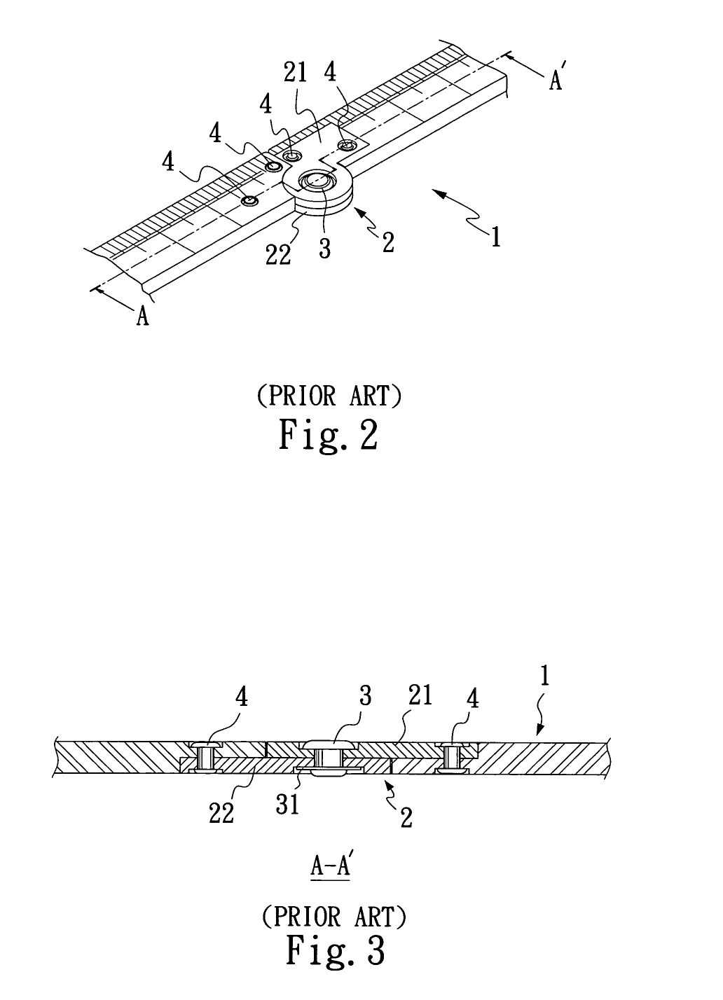

### DETAILED DESCRIPTION OF THE PREFERRED EMBODIMENTS

Some of the objects of the invention have been set forth above. Other objects and advantages of the present invention will appear as the invention when taken in conjunction with the following embodiment and drawings.

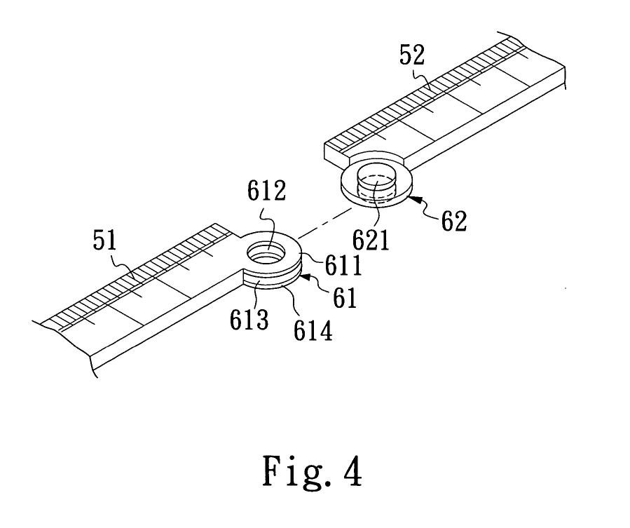

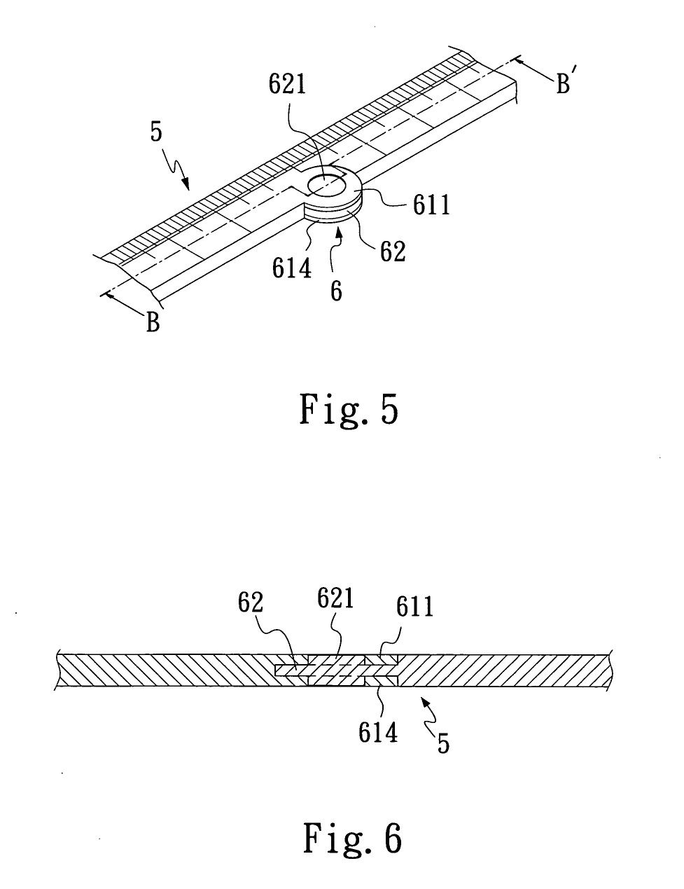

First, please referring to FIG. 4 illustrated the explosive view of the present invention and referring to FIG. 5 and FIG. 6 illustrated the assembly view and cross-section view respectively. The present invention includes two rulers 51, 52; an axis 6 composed of a hollow axis 61 and a fixed axis 62; the hollow axis 61 and the fixed axis 62 are formed as one respectively to the end of the ruler 51, 52; the hollow axis is composed of an upper ring 611 and an lower ring 614; a through hole 612 set between the upper ring 611 and the lower ring 614; a trench 613 set between the through hole 612; and blocks 621 set on the upper and lower surfaces of the fixed axis 62 respectively. Plugging the fixed axis 62 into the trench 613 of the hollow axis 61, wherein the blocks 621 set on the upper and lower surfaces of the fixed axis 62 fix to the through hole 612 set between the upper ring 611 and the lower ring 614 of the hollow axis 61 to combine the hollow axis 61 and the fixed axis 62 to reach goals of fewer elements, low cost and replacing easily.

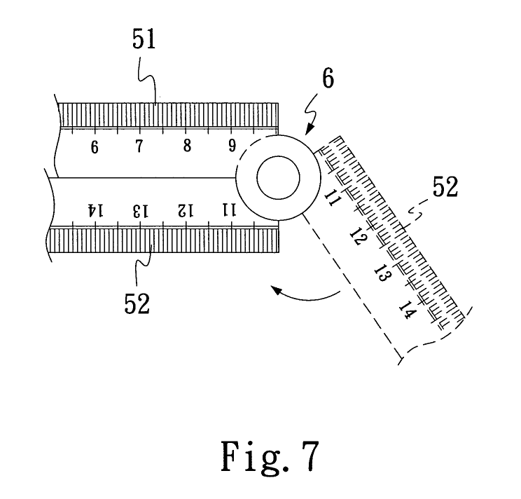

Please referring to FIG. 7 illustrated an embodiment of the present invention, the ruler 51 can be received besides the other ruler 52 by means of axis 6 to obtain improvement structure of the ruler of fewer elements, low cost and replacing rapidly.

Various details of the invention may be changed without departing from its scope. Furthermore, the foregoing description of the preferred embodiments of the invention and the best mode for practicing the invention are provided for the purpose of illustration only and not for the purpose of limitation—the invention being defined by the claims.

1. An improvement structure of a ruler, comprising:
two rulers;
an axis, composed of a hollow axis and a fixed axis, said hollow axis and said fixed axis being formed as one respectively to the ends of said rulers, said hollow axis being composed of an upper ring and an lower ring to combine said two rulers as one.

2. An improvement structure of a ruler as claimed as claim 1, wherein the center of said upper ring and said lower ring set a through hole.

3. An improvement structure of a ruler as claimed as claim 1, wherein the gap of said upper ring and said lower ring set a trench.

4. An improvement structure of a ruler as claimed as claim 1, wherein the upper surface and the lower surface of said fixed axis set a block respectively.
